(19) United States
(12) Patent Application Publication
(10) Pub. No.: US 2015/0356258 A1
(43) Pub. Date: Dec. 10, 2015

(54) REAL-TIME NATIONAL RADIATION DOSE DATABASE AND MONITORING RADIATION DOSAGES USING THIS DATABASE

(71) Applicant: THE RESEARCH FOUNDATION FOR THE STATE UNIVERISTY OF NEW YORK, Albany, NY (US)

(72) Inventor: William MOORE, Setauket, NY (US)

(73) Assignee: THE RESEARCH FOUNDATION FOR THE STATE UNIVERSITY OF NEW YORK, Albany, NY (US)

(21) Appl. No.: 14/763,007

(22) PCT Filed: Jan. 24, 2014
(86) PCT No.: PCT/US2014/012912

§ 371 Date: Jul. 23, 2015

Related U.S. Application Data
(60) Provisional application No. 61/849,301, filed on Jan. 24, 2013.

(51) Int. Cl. G06F 19/00

(52) U.S. Cl. CPC G06F 19/327

(57) ABSTRACT

An inventive system and method for monitoring radiation dose data comprises in one aspect, a database storing at least recommended dose data and benchmark dose data for one or more facilities, a scanner located in one facility, the scanner can perform a scan with radiation dose data, an application server, a user interface comprising at least a display, and a module, operable on the processor, to receive the radiation dose data from the scanner, store the radiation dose data, monitor the radiation dose data in accordance with effective dose data and the benchmark dose data for the facilities, and display the monitored dose data and the benchmark dose data for the facility. In one aspect, convert the radiation dose data in accordance with the recommended dose data stored in the database and obtain an effective dose data based on the converted radiation dose data.

### CROSS REFERENCE TO RELATED APPLICATIONS

The present application claims benefit of U.S. Provisional Application No. 61/849,301, filed Jan. 24, 2013, the entire contents of which are incorporated herein by reference.

### FIELD OF THE INVENTION

The present invention relates generally to monitoring and/or regulating radiation dosage, and in particular to providing benchmark radiation dosages for a variety of studies to a facility.

### BACKGROUND OF THE DISCLOSURE

Increased public and regulatory scrutiny of imaging-related radiation exposure requires familiarity with current dose-monitoring techniques and best practices. Computed Tomography-related ionizing radiation exposure has been cited as the largest and fastest growing source of population-wide iatrogenic ionizing radiation exposure. Upcoming federal regulations require imaging centers to familiarize themselves with available dose-monitoring techniques and implement comprehensive strategies to track patient dose, with particular emphasis on Computed Tomography (CT). Because of institution-specific and vendor-specific technologies, there are significant barriers to adoption and implementation of comprehensive dose-monitoring of radiation exposure.

Thus there is a need for a system and method that provides a benchmark radiation dose for a variety of studies to a facility and that enables radiation dose monitoring.

### SUMMARY OF THE DISCLOSURE

A novel system and method for radiation dose monitoring is presented. The system uses a particular study (e.g., patient-centered) approach to radiation dose tracking that empowers imaging centers, interventionalists and affiliated services to rapidly track patient specific radiation doses.

In one aspect, the method can comprise scanning, using a scanner at one facility of one or more facilities, storing the radiation dose data, monitoring monitor data based on the monitor data, e.g., effective dose data or CT Dose Index (CTDI) volume or Dose Length Product (DLP), and the benchmark dose data for the one or more facilities; and displaying, on the display, the monitor data, e.g., effective dose data, DLP or CTDI volume, and the benchmark dose data for the one facility. In one aspect, the method can also comprise converting the radiation dose data in accordance with recommended dose data stored in a database and obtaining the effective dose data based on the converted radiation dose data.

In one aspect, the system can comprise a database storing at least recommended dose data and benchmark dose data for one or more facilities, a scanner located in one facility of the one or more facilities, the scanner can perform a scan with radiation dose data, an application server having a processor, a user interface comprising at least a display, and a module operable on the processor, said module operable to receive the radiation dose data from the scanner, store the radiation dose data, monitor the radiation dose data based on the monitor data, e.g., effective dose data or CTDI volume or DLP, and the benchmark dose data for the one or more facilities, and display, on the display, the monitor data, e.g., the effective dose data or CTDI volume or DLP, and the benchmark dose data for the one facility. In one aspect, the module can be further operable to convert the radiation dose data in accordance with the recommended dose data stored in the database and to obtain the effective dose data based on the converted radiation dose data.

In one aspect, the system and method further comprises displaying, on the display device, the benchmark dose data for one or more facilities in addition to the one facility. In one aspect the system and method further comprises enabling a user to enter authentication data, and authenticating the user. In one aspect, the system further comprises a printer, wherein the module is further operable to send the effective dose data and the benchmark dose data to the printer.

A computer readable storage medium storing a program of instructions executable by a machine to perform one or more methods described herein also may be provided.

### BRIEF DESCRIPTION OF THE DRAWINGS

These and other features, aspects, and advantages of the apparatus of the present invention will become better understood with regard to the following description, appended claims, and accompanying drawings where:

FIG. 1 shows the system architecture for an embodiment of the inventive system.

FIG. 2 is an exemplary workflow diagram for an embodiment of the present invention.

FIG. 3 is an exemplary graphic display of radiation dose comparisons for a particular study.

FIG. 4 is an exemplary dose sheet for a specific scanner manufacturer.

### DETAILED DESCRIPTION OF DISCLOSURE

A novel system and method and computer program for radiation dose monitoring for a variety of studies is presented.

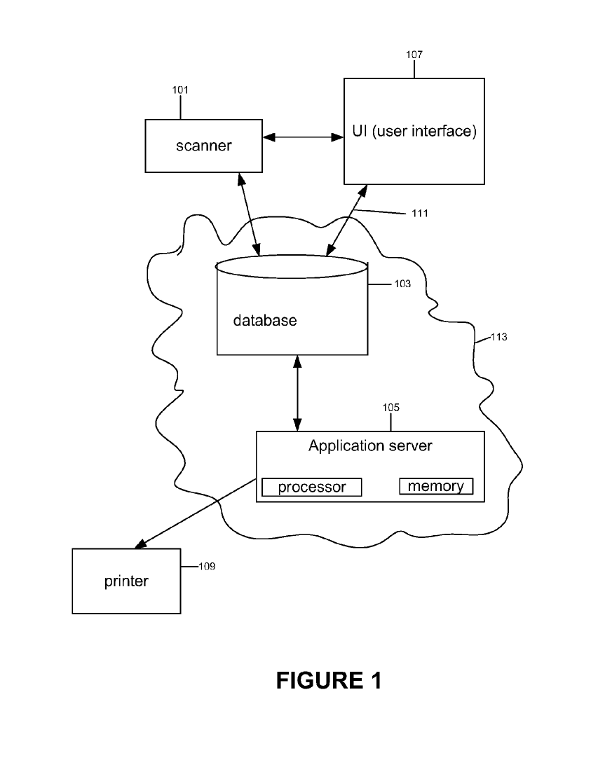

FIG. 1 is a high-level architectural schematic of an embodiment of the inventive system. As shown in FIG. 1, the system has one or more scanners 101, a database 103 in which data including dose information is stored, and an application server 105 having memory in which algorithms for performing dose monitoring in accordance with the present invention are stored. The application server can include a hardware processor, processing device and/or CPU, storage and memory. End users, such as CT technologists, can interact with the system via a user interface (UI) 107 having a graphical interface or GUI. The results can be displayed by the system on the display of the UI 107 and/or printed on a printer 109. The UI 107 can communicate with the database 103, the application server 105, and/or the printer 109 via a network 111. The database 103 and the application server 105 can be cloud-based. For example, FIG. 1 shows the database 103 and the application server 105 in a cloud 113.

Because the system is vendor-neutral, the scanners 101 can be from any vendor. Vendors can include General Electric, Philips, Toshiba, Siemens and other scanner manufacturers. Multiple specialties can use the system, including radiology, cardiology, oncology, urology, etc. Multiple modalities can be used including CT, Angiography, fluoroscopy, digital radiography, digital mammography, breast tomosynthesis, etc. The network 111 can be a local area network (LAN), intranet, internet, or any other communication network as known to one skilled in the art.

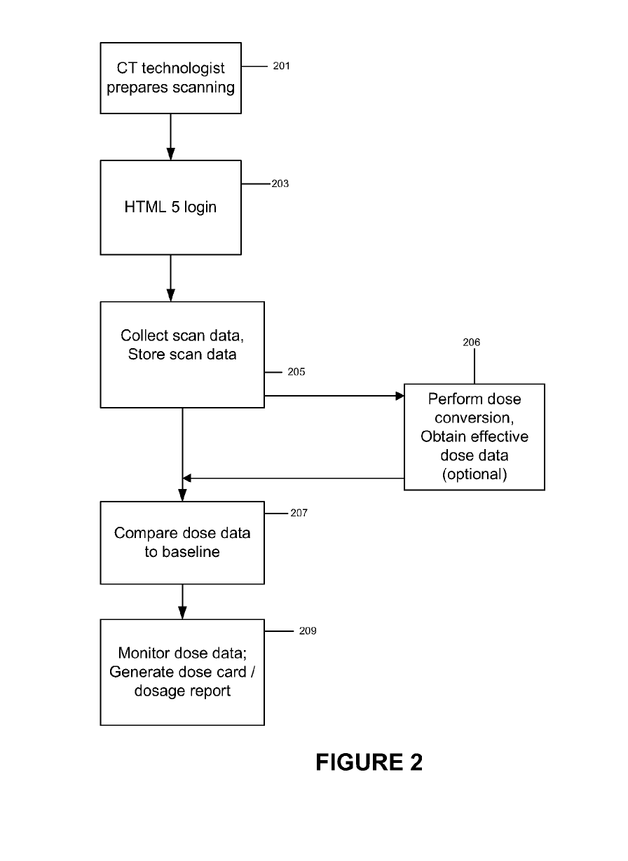

FIG. 2 is a workflow model for an embodiment of the present invention. This workflow allows technologists to generate a customized branded card or printout for a patient after an examination, eliminating the need for verbal feedback regarding dose. This may or may not include the current and cumulative dose values for the examination. As shown in FIG. 2, in step S201, a scanner, e.g., CT scanner, is operated by a CT technician, e.g., technologist, who prepares for scanning. In one aspect, the scanner is automatically logged into the inventive system. In step S203, the login can be performed by HTML 5 login procedures. Each technologist login requires user specific credentials. The system will automatically register to the CT scanner based on the location of the computer used to log into the system. An administrator log-in is also available; this will allow an administrator to monitor all radiation producing units at his or her facility.

The system is secured by an SSL (security sockets layer) application engine on a node replicated via cloud instances. SSL uses public and private keys, along with digital certificates, for security. In some embodiments, SSL can be replaced with TLS (transport layer security). The system employs SSH (secure shell) protocol to enable SSH tunnels, e.g., encrypted tunnels, to provide secure remote login and access over insecure networks, such as over the cloud.

Application security can be obtained, in addition to SSH tunnels, by enforcing user authorization and application authorization in accordance with required credentials for system access. Additional security can be obtained from database security including, for example, failover protection node replication and/or regular database backup.

In step S205, scan, or radiation dose, data is collected and stored in the database 103. In one embodiment, in optional step S206, the collected data is converted and effective dose data is obtained at the time of the scan. Dose data can be received and collected from the radiation producing unit in different ways. For example, modern equipment produces a Digital Imaging and Communication in Medicine (DICOM) public field called DICOM SR (Structured Report). In this report, the radiation dose parameters are displayed. The inventive system can collect the DICOM SR information and store the appropriate information. In one embodiment, the dose data can be converted in step S206. However, older equipment (the majority of the equipment available in the United States at present) does not conform to DICOM. Hence, the dose data can be collected by performing Optical Character Recognition (OCR) on the dose sheets. Typically, CTDI volume, DLP, technologist name, and all other DICOM fields, in addition to patient demographics, are collected and sent to the database 103.

In step S207, after the examination, e.g., after operation of the scanner, the effective dose data is compared to baseline data obtained from the database 103. In step S209, the radiation dose is monitored for a particular patient and a customized, branded dose card and/or a printout of the dose data for the patient is generated. In one aspect, the radiation dose is monitored in accordance with “monitor data” which can be one of effective dose data, CTDI volume or DLP.

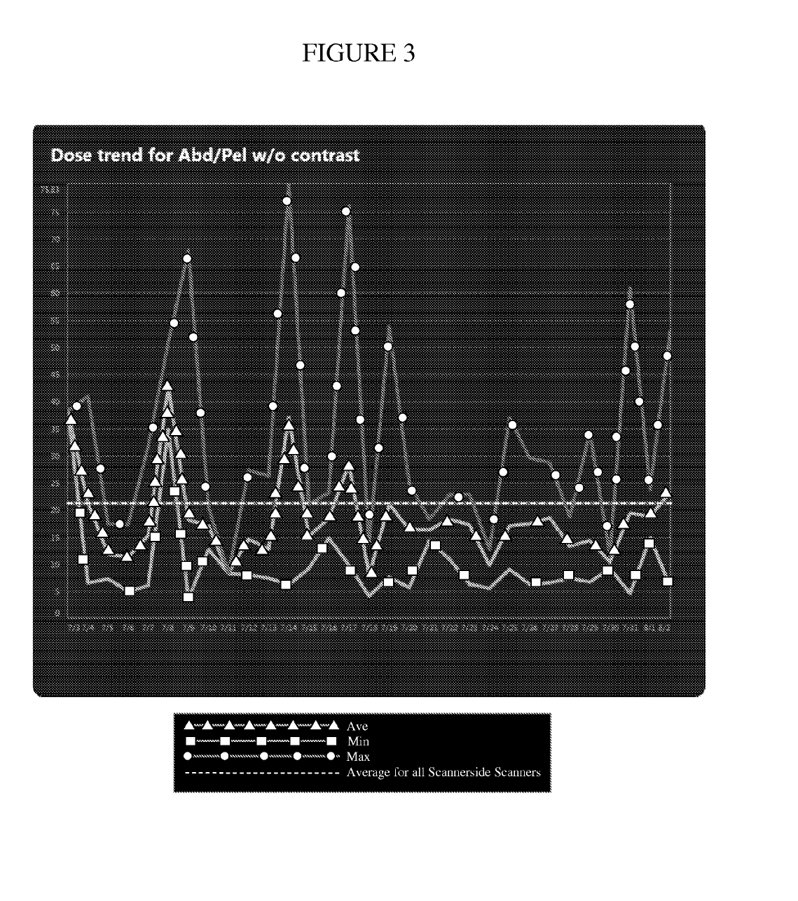

FIG. 3 shows an HTML 5 graphical display illustrating output from the inventive system and method. Such a display, which can appear on a UI 107 and/or can be printed, can be used to enhance patient and referring physician communication, as discussed in more detail below. The real-time national radiation dose database provides a benchmark radiation dose for a particular study to a facility. The dotted line in FIG. 3 shows the running national average radiation dose. The line marked with triangles in FIG. 3 shows the facilities average radiation dose. This allows the facility to understand where their radiation dose is compared to the other facilities within the country. The mean radiation dose provided in this system is a thirty day running mean of all the radiation doses; the inventive system and method collects this mean radiation dose for this particular type of study.

In one embodiment, the inventive system is based in cloud architecture which enables assessment of the data for multiple facilities. In one embodiment, the mean radiation dose at a thirty day running average can be displayed for each different type of imaging study. The cloud architecture allows for display on an HTML 5 graphical display the mean facility radiation dose. For example, as shown in FIG. 3, the line marked with triangles is compared to the national mean radiation dose, the dotted line. This system is used by hospitals and imaging facilities to benchmark their radiation dose to other imaging centers radiation dose. The graphical display allow for ease of use of the system.

The most accurate method of determining organ specific dose requires mathematical Monte Carlo simulation and phantom anatomic modeling. Although this method may underestimate actual organ-specific dose, it is the currently accepted model of estimating true organ dose. The alternative method of dose calculation is the effective estimate, which does not involve phantom modeling or Monte Carlo simulation and possesses a significant advantage from a computational standpoint.

A newly discussed alternative to adjusting for patient body habitus, e.g., physique or body type, is the size specific dose estimate (SSDE) calculation. Using this alternative requires the ability to estimate phantom size from patient body habitus as established by scout images in one or two dimensions. The SSDE calculation allows for more accurate dose estimation but cannot be converted to an effective dose or sequentially added to obtain a cumulative dose. In one embodiment, the SSDE can be provided as an alternative measure alongside effective dose (mSV). Generally, effective dose (mSV) offers the most practical approach.

In addition to dose calculation, actual or estimated, another challenge is to capturing dose information from existing CT scanners. In the novel solution to this challenge, a modular architecture that allows efficient load balancing and processing of dose sheets for optical character recognition (OCR) can be implemented. In one embodiment, server-side worker thread pools can be used to more efficiently execute the load balancing and processing tasks. The solution can be implemented on a cloud-based service which removes the need for onsite hardware and the associated costs, enabling a robust, cost-effective, simple, automated radiation dose-tracking platform.

The inventive robust platform that allows dose monitoring can include six major components: dose capture, effective dose conversion, patient-specific storage, dose analytics, dose communication, and data export. Each is discussed in more detail below.

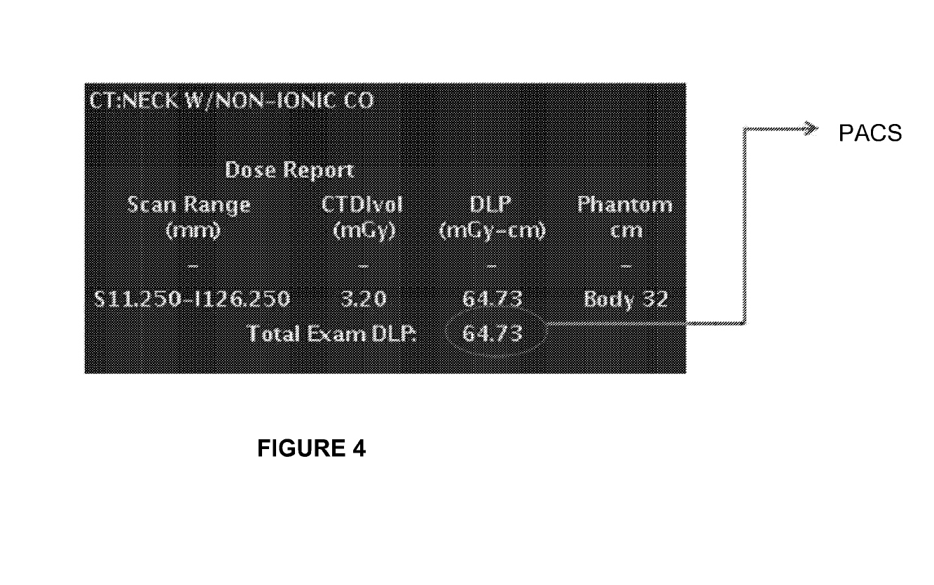

DOSE CAPTURE: Traditionally, radiation dose information arising from CT scans and other examinations has not been available in computer readable format as a standard component. Instead, most scanners provide these data in image format, which is then stored in the PACS as a separate series. The critical dose data, including volume CT dose index (CTDIvol) and dose-length product (DLP), is effectively “burned” into a PACS image without a textual or numeric correlate. FIG. 4 shows an exemplary PACS image based on a specific scanner manufacturer, e.g., General Electric. The example dose sheet has CO=contrast; CTDIvol=volume CT dose index; DLP=dose length product; OCR=optical character recognition; and SR=structured report. Conversion into a value that can be parsed thus requires “image reading” using custom-trained OCR algorithms. Developing such algorithms with sufficient accuracy is a significant challenge. However, with the introduction of Digital Imaging and Communication in Medicine (“DICOM”) structured reporting (“DICOM-SR)”, dose information has become available as a standard component in the DICOM header set.

To enable universal implementation of a dose monitoring system, a dose platform can be implemented that supports extracting dose data from prior dose sheets. In the inventive solution, a cloud-based multinode architecture can be used to provide OCR from the dose information sheet from a CT examination. In one embodiment, an OCR algorithm can be optimized from a central location allowing fine-tuning of accurately capturing dose data across multiple vendors.

In one aspect, use of OCR can be avoided by calculating dosage length product (DLP) from DICOM header information sent with each image. Recent work has suggested that CTDIvol and DLP calculation may be possible by collecting headers per slice (tube voltage and tube current-time product) and accounting for pitch. The challenge of this approach is that dose calculation requires series identification (reconstructed or reformatted images versus new passes), which has yet to become fully automated.

In another aspect, the DLP value can be calculated by using tube voltage and tube current data and a lookup table for CTDIvol data, as is available for manual use via the imPACT project. The challenge of identifying reconstructed versus new-pass series still exists. Separating these series from true new passes requires custom development and machine-specific or vendor specific code. Incorrectly doing so would mean doubling or tripling the dose for a given examination, depending on the number of reconstructed series.

Certain types of legacy scanners use a message identifier known as modality-performed procedure step, e.g., dose monitoring, as part of the DICOM field structure that stores dose data as key-value pairs in the DICOM header. In one aspect, this information can be captured to allow automated dose capture much like DICOM-SR. However, these DICOM fields are often private, and typically are variable not standardized into a particular format.

In one aspect, DICOM header messages under the DICOM-SR protocol can provide a method for dose capture from CT because DLP and CTDIvol values will be in numeric format in public DICOM header fields. Unfortunately, a majority of CT scanners do not send DICOM-SR messages.

In one embodiment, manual dose entry by CT technologists can be performed. Although there is potential for error, prior work in semi-automated dose entry has found approximately 94% accurate dose capture from technologists. The majority of errors from dose entry were due to identifiable and correctable causes, such as incorrect decimal placement. Of these errors, 90% were easily correctable in retrospect. Given the ease of setup and use, this embodiment of dose monitoring can be used, which avoids vendor-specific and technical issues. Because dose is entered at the time of the examination, it promotes CT technologist awareness and direct patient communication. In one aspect, the manual entry process can be performed as a web-based service.

In one embodiment, automated dose-entry workflow allows the performing technologist to access a secure portal with the ability to generate a patient printout (or dose card) for communication. This portal remains open throughout the day and can handle multiple examinations.

The dose-capture methods discussed above apply only to CT scanner-specific dose. Capturing non-CT and procedural dose requires tools using DICOM-SR or dose-entry tools. For example, OCR or modality-performed procedure step dose monitoring does not allow for fluoroscopic or angiographic dose tracking. However, the present invention allows angiographic dose tracking.

Effective Dose Conversion

Delivered dose from a CT examination can initially be presented as CTDIvol, which represents the estimated dose of a single weighted CT slice accounting for CT pitch. DLP is CTDIvol multiplied by scan length (cm). To estimate the effective dose, DLP may be multiplied by a conversion factor to obtain millisievert values, as follows:

effective dose (mSv)=DLP×k (conversion factor in mSv)

As previously mentioned, organ-specific values may be calculated using more advanced Monte Carlo techniques, which do vary from the above millisievert values. However, the above method of calculating effective dose provides a sufficient estimate of patient risk for most purposes, without the extensive calculation and modeling necessary to calculate organ-specific dose in a practical setting. Calculated millisievert values may be serially added to estimate cumulative patient risk.

An accurate k factor requires patient age and habitus and examination type, which may be either stored for later calculation or used after dose capture to calculate the effective dose.

Although OCR and DICOM-SR tools allow potentially automated dose capture and communication, these tools do not, by default, handle effective dose conversion or patient-specific storage or aggregation. Accordingly, in one embodiment, effective dose conversion can be incorporated at the time of the scan, before generating patient printouts for communication. Validated k-factor tables can be used to convert to effective dose, which varies for pediatric and bariatric patients.

Patient-Specific Storage

Storing examination information can be managed through a distributed relational database with a schema that allows query-based reporting. Structured query language (eg, MySQL®; Oracle Corporation, Redwood Shores, Calif.) or “not only structured query language” databases can be used. In one aspect, dose information has internal references to identifying patient information such as medical record number or identifier, in a HIPAA compliant manner.

In one embodiment, integration with internal hospital based electronic medical record (EMR) systems can be enabled to facilitate clinical decision making. The integration can be done via Health Level 7 protocol information transfer or API integration from an external storage source. Once the data are transferred, EMR-specific components to process dose information could then incorporate cumulative patient dose into clinical decision making or ordering systems.

In one embodiment, the cloud stores encrypted dose information using an elastic, scalable, and relational database adhering to the necessary HIPAA requirements. Data can be transferred securely to a remote location via the Health Level 7 protocol or API integration, which can be integrated with internal EMR systems or decision systems in a customized institution specific fashion. Advantages of cloud architecture can include significantly reduced costs and improved scalability.

Institutional Dose Reporting

A real-time graphical display of dose data can allow the optimization of doses and protocols. In a data-driven department, this can be valuable in day-to-day operations. Flagging scans with certain millisievert values, for example, can allow the identification of problem areas and the potential for protocol improvement. Reporting packages can provide sufficient information to monitor the effects of altering protocols.

Comprehensive dose reporting requires scanner specific and patient-specific reports for a given time frame. Scanner-specific reports can illustrate the maximum effective dose (mSv) per examination in a given time frame, trends in dose, and comparison information. Patient-specific reports can provide a summary of patient cumulative dose and examination details for a given medical record number or patient identifier.

In one embodiment, these analytics are provided in a graphical display, which displays scanner-specific and patient-specific data for a given time frame. In one aspect, these reports can be used to track protocol changes over time and reduce delivered patient dose. The inventive solution has the advantage of providing real-time feedback from our multi-center dose-reporting database for technologists per examination relative to a real-time average in the inventive cloud-based database.

Patient and Referring Physician Communication

Dose communication can be a useful component of a dose-monitoring platform. Data communication options can include patient health records, radiology reports, and direct referring physician communication. The choice of appropriate communication can depend on the institution. Typically, simple patient dose communication after a scan followed by cumulative communication that is easy to access in the health record improves both patient and referring physician satisfaction while safely not reducing overall scan volume. Reporting can be performed in a manner that reassures patients without causing undue concern.

Other existing tools do not offer direct real-time patient or technologist communication. Technologist-driven verbal patient feedback regarding dose after each examination can become cumbersome and interruptive to workflow. By contrast, in the present invention, easy-to-print custom patient marketing materials can be produced after a scan. Hence, the present system can provide reassurance to a patient that dose is being tracked without causing undue concern. Doing so begins to establish, for example, a relationship with the imaging center and a potential for repeat business.

In one embodiment, the cloud-based automated dose-tracking platform can use HTML5 push notifications to generate custom dose printouts or cards as soon as an examination is processed. While tools are available to offer radiology information system communication for automated entry to radiology reports, the ability to monitor radiation dose using an easy-to-use graphical system disclosed in the present invention provides benefits at the point-of-care.

In one aspect, dose monitoring empowers radiologists and imaging centers to serve as “dose consultants” by being able to query dose data for given patients. This is a value-added benefit to hospitals and referring physicians. In addition to automated dose reporting into the health record, a comprehensive dose-monitoring service can allow case-by-case patient consultation with referring physicians regarding overutilized examinations and decrease ordering anxiety by reassuring referring physicians that patient dose is being tracked internally. In one aspect of the present invention, the involvement of radiologists in dose monitoring can be minimal, and technologists can be at the point of care.

Data Export

The use of a dose registry can allow obtaining multicentric or geographic dose data and benchmarks for participating institutions. Initiatives by the American College of Radiology (ACR) such as the Dose Index Registry aim to catalogue and monitor institution-specific doses. The ACR Dose Index Registry supports DICOM-SR for dose capture as well as OCR with many vendor partners. A list of compatible and supported ACR Dose Index Registry tools may be found at the ACR's website.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided. A non-tangible computer readable storage medium does not include the tangible computer readable medium of signals.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc. The system also may be implemented on a virtual computer system, colloquially known as a cloud.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A system for monitoring radiation dose data, comprising:
a database storing at least recommended dose data and benchmark dose data for one or more facilities;
a scanner located in one facility of the one or more facilities, the scanner operable to perform a scan with radiation dose data;
an application server having a processor;
a user interface comprising at least a display; and
a module operable on the processor, said module operable to receive the radiation dose data from the scanner, store the radiation dose data, monitor the radiation dose data based on monitor data and the benchmark dose data for the one or more facilities, and display, on the display, the monitor data and the benchmark dose data for the one facility.

2. The system according to claim 1, wherein the module is further operable to:
convert the radiation dose data in accordance with the recommended dose data stored in the database; and
obtain the monitor data based on the converted radiation dose data.

3. The system according to claim 1, wherein the module is further operable to display the benchmark dose data for one or more facilities in addition to the one facility.

4. The system according to claim 1, wherein the user interface further comprises a device enabling a user to enter authentication data, and the module is further operable to authenticate the user.

5. The system according to claim 1, further comprising a printer, wherein the module is further operable to send the effective dose data and the benchmark dose data to the printer.

6. The system according to claim 1, wherein monitor data is one of effective dose data, Dose Length Product and Computed Tomography Dose Index Volume.

7. A method for monitoring radiation dose data, comprising steps of:
scanning, using a scanner at one facility of one or more facilities, with radiation dose data;
storing, in a database, the radiation dose data along with benchmark dose data and recommended dose data for the one or more facilities;
monitoring the radiation dose data based on monitor data and the benchmark dose data for the one or more facilities; and
displaying, on the display, the monitor data and the benchmark dose data for the one facility.

8. The method according to claim 7, further comprising:
converting the radiation dose data in accordance with the recommended dose data stored in the database; and
obtaining the monitor data based on the converted radiation dose data.

9. The method according to claim 7, further comprising displaying, on the display device, the benchmark dose data for one or more facilities in addition to the one facility.

10. The method according to claim 7, further comprising steps of:
enabling a user to enter authentication data; and
authenticating the user.

11. The method according to claim 7, further comprising sending the monitor data and the benchmark dose data to a printer.

12. The method according to claim 7, wherein monitor data is one of effective dose data, Dose Length Product and Computed Tomography Dose Index Volume.

13. A computer readable storage device storing a program of instructions executable by a machine to perform a method for monitoring radiation dose data, comprising:
scanning, using a scanner at one facility of one or more facilities, with radiation dose data;
storing, in a database, the radiation dose data along with benchmark dose data and recommended dose data for the one or more facilities;
monitoring the radiation dose data based on monitor data and the benchmark dose data for the one or more facilities; and
displaying, on the display, the monitor data and the benchmark dose data for the one facility.

14. The program of instructions according to claim 13, further comprising:
converting the radiation dose data in accordance with the recommended dose data stored in the database; and
obtaining the monitor data based on the converted radiation dose data.

15. The program of instructions according to claim 13, further comprising displaying, on the display device, the benchmark dose data for one or more facilities in addition to the one facility.

16. The program of instructions according to claim 13, further comprising steps of:
enabling a user to enter authentication data; and
authenticating the user.

17. The program of instructions according to claim 13, further comprising sending the monitor data and the benchmark dose data to a printer.

18. The program of instructions according to claim 13, wherein monitor data is one of effective dose data, Dose Length Product and Computed Tomography Dose Index Volume.
